(19) United States
(12) Patent Application Publication
(10) Pub. No.: US 2008/0310049 A1
(43) Pub. Date: Dec. 18, 2008

(54) Fluid dyamic bearing with novel air-gap

(76) Inventors: Jr-Yi Shen, Sunnyvale, CA (US); Kunihiro Shida, San Jose, CA (US)

Correspondence Address: HITACHI C/O WAGNER BLECHER LLP, 123 WESTRIDGE DRIVE, WATSONVILLE, CA, 95076, US

(21) Appl. No.: 11/818,068

(22) Filed: Jun. 12, 2007

(51) Int. Cl. G11B 17/02; B21D 53/00

(52) U.S. Cl. 360/98.08; 29/898.02; 29/898.04; 29/898.041

(57) ABSTRACT

A fluid dynamic bearing with a modified air-gap is disclosed. One embodiment provides a clamp adjacent to the fluid dynamic bearing, the clamp for clamping at least one disk with respect to the fluid dynamic bearing. In addition, a cap is also provided proximal to a shaft of the fluid dynamic bearing, the cap having an outer end proximal to the clamp such that an air-gap is provided between the outer end of the cap and the clamp.

### TECHNICAL FIELD

The present invention relates to the field of hard disk drive development, and more particularly to resolving particulate contamination in a fluid dynamic bearing.

### BACKGROUND ART

Direct access storage devices (DASD) have become part of every day life, and as such, expectations and demands continually increase for greater speed for manipulating data and for holding larger amounts of data. To meet these demands for increased performance, the mechanical assembly in a DASD device, specifically the Hard Disk Drive (HDD) has undergone many changes.

In operation, the hard disk is rotated at a set speed via a spindle motor assembly having a central drive hub. Additionally, there are tracks evenly spaced at known intervals across the disk. When a request for a read of a specific portion or track is received, the hard disk aligns the head, via the arm, over the specific track location and the head reads the information from the disk. In-the same manner, when a request for a write of a specific portion or track is received, the hard disk aligns the head, via the arm, over the specific track location and the head writes the information to the disk.

Areal densities of hard disk drives (HDD) in the past have increased at significant rates of 60 percent to more than 100 percent per year. This trend has slowed more recently to approximately 40 percent per year due to technology challenges. Areal densities today are close to 100 Gb/in2. HDDs are being used more often as digital applications in the consumer electronics industry proliferates, requiring much higher capacities and setting new expectation for lower acoustics. All of the above makes fluid dynamic bearing spindle motors attractive for minimizing non repeatable run-out (NRRO), lowering acoustical noise, and improving reliability.

Presently, the transition from ball bearing (BB) spindle motors to fluid dynamic bearings (FDB) is almost complete in the HDD industry. In general, by incorporating FDB motors in HDD designs higher areal densities and much faster spindle speeds are achieved for today's applications. For example, NRRO is the highest contributor to track mis-registration (TMR), thus impacting HDD performance. NRRO is also an inhibitor in achieving higher track densities. Ball bearing motors produce larger NRRO due to the mechanical contact with the inherent defects found in the geometry of the race ball interface and the lubricant film. Ball bearing spindle motors have minimized this issue with tighter tolerances and closer inspections. There is an upper limit beyond which the ball bearing design can no longer overcome the NRRO problem at the higher areal densities. Currently with ball bearings, NRRO has settled in the 0.1 micro-inch range.

By contrast, FDBs generate less NRRO due to absence of contact between the sleeve and stator. FDB designs are expected to limit NRRO in the range of 0.01 micro-inch. Other inherent properties of the FDB design are higher damping, reduced resonance, better non-operational shock resistance, greater speed control, and improved acoustics. Non-operational shock improvement is a result of a much larger area of surface-to-surface contact. Noise levels are reduced to approximately 20 dBA, since there is no contributing noise from ball bearings.

However, one problem with FDB is the contamination of the lubrication or fluid within the bearing. Basically, particulate contamination of the lubrication fluid greatly decreases the life of the bearing.

### SUMMARY

A fluid dynamic bearing with a modified air-gap is disclosed. One embodiment provides a clamp adjacent to the fluid dynamic bearing, the clamp for clamping at least one disk with respect to the fluid dynamic bearing. In addition, a cap is also provided proximal to a shaft of the fluid dynamic bearing, the cap having an outer end proximal to the clamp such that an air-gap is provided between the outer end of the cap and the clamp.

### BRIEF DESCRIPTION OF THE DRAWINGS

FIG. 1A is a plan view of an HDD with cover and top magnet removed in accordance with one embodiment of the present invention.

FIG. 1B is an isometric blow-apart of an HDD in accordance with one embodiment of the present invention.

FIG. 2 is an exemplary cross-sectional view of a portion of a fluid dynamic bearing in accordance with one embodiment of the present invention.

FIG. 3A is an isometric view of an exemplary cap/clamp orientation having an air-gap with a horizontal opening in accordance with one embodiment of the present invention.

FIG. 3B is an isometric view of an exemplary cap/clamp orientation having an air-gap with an angled opening in accordance with one embodiment of the present invention.

FIG. 3C is an isometric view of an exemplary cap/clamp orientation having an air-gap with a vertical opening in accordance with one embodiment of the present invention.

FIG. 4 is a flowchart of a method for forming a fluid dynamic bearing with a modified air-gap in accordance with one embodiment of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of a hard disk drive and components connected therewith. The discussion will then focus on embodiments of a method and system for forming a fluid dynamic bearing (FDB) with a modified air-gap in particular. Although the fluid dynamic bearing is shown in a hard disk drive, it is understood that the embodiments described herein are useful in a fluid dynamic bearing regardless of whether the fluid dynamic bearing is a portion of a hard disk drive. The utilization of the fluid dynamic bearing within the HDD is only one embodiment and is provided herein merely for purposes of brevity and clarity.

### Overview

In general, embodiments of the present invention provide a method and apparatus for forming a fluid dynamic bearing with a modified air-gap. For example, one problem with traditional fluid dynamic bearing (FDB) is the contamination of the lubrication or fluid within the bearing. As particulate works through the gap between the cap and the shaft of the FDB, the fluid is contaminated causing the fluid to retain more heat thereby causing further internal contamination. This results in additional fluid contamination and reduced friction capability of the fluid in the FDB. In other words, once the fluid contamination begins, the time to catastrophic failure is significantly reduced.

However, by utilizing the cap/clamp implementation described herein, the possibility for contaminating the fluid within the FDB is significantly reduced without requiring any modification to other components of the fluid dynamic bearing. In other words, the pressure adjusting capabilities of the fluid dynamic bearing is maintained via the new air-gap while the possible contamination of the fluid within the FDB are significantly decreased.

### Operation

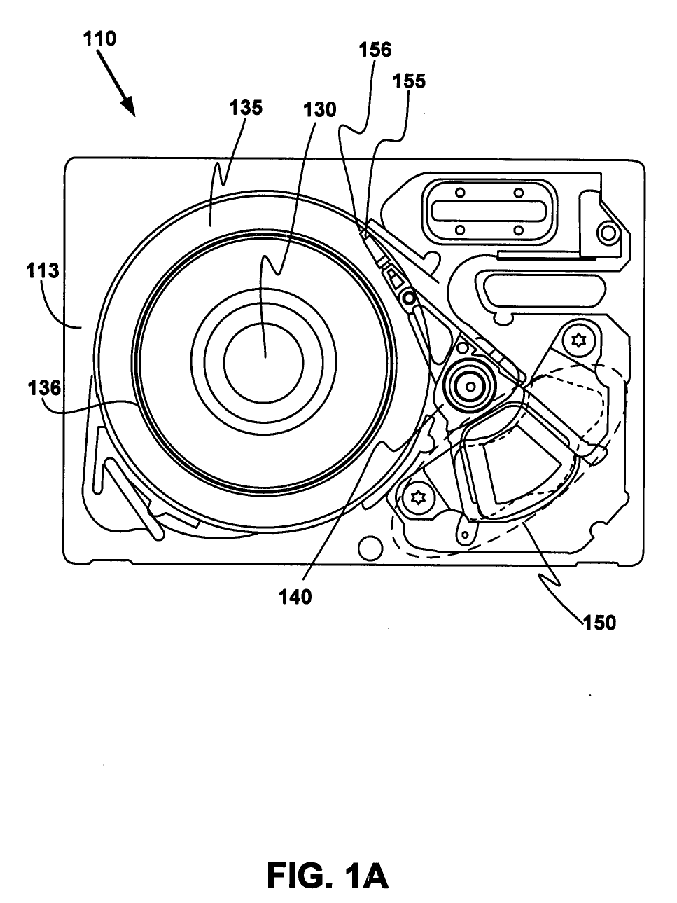

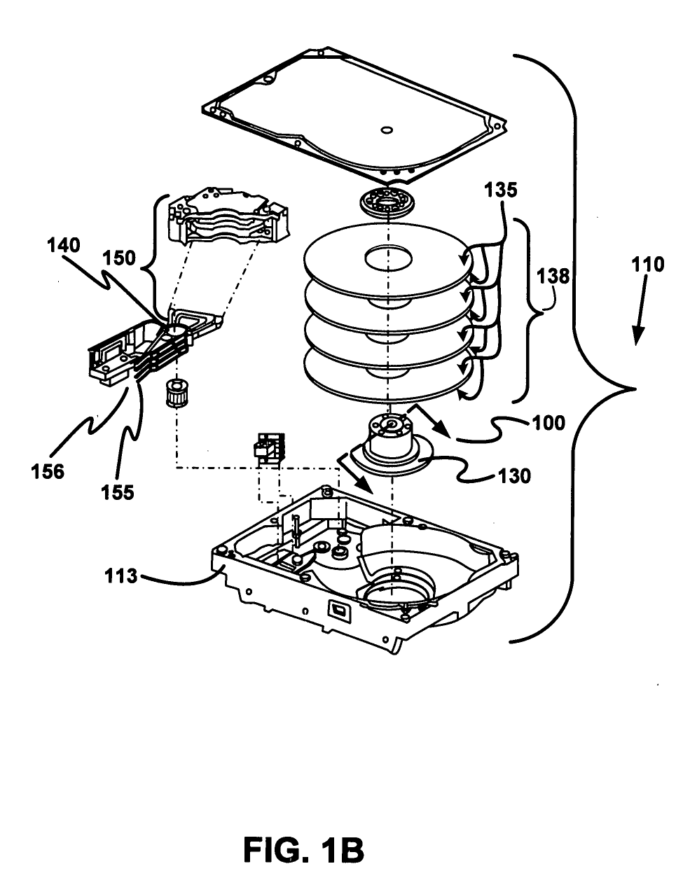

With reference now to FIG. 1A, the relationship of components and sub-assemblies of a hard disk drive (HDD) 110 having a single hard disk drive 138 and a representation of data tracks 136 recorded on disk surface 135 is shown. In general, the cover is removed and not shown so that the inside of HDD 110 is visible. FIG. 1B shows a similar HDD 110, but with all its components in an isometric blow-apart view. The components, such as the plurality of hard disk drives 138, are assembled into base casting 113, which provides attachment and registration points for components and sub-assemblies. Data is recorded onto disk surface 135 in a pattern of concentric rings known as data tracks 136. Disk surface 135 is spun at high speed by means of a motor-hub assembly 130. Data tracks 136 are recorded onto disk surface 135 by means of magnetic head 156, which typically resides at the end of slider 155. FIG. 1A being a plan view shows only one head and one disk surface combination. One skilled in the art understands that what is described may be used for one head-disk combination or a plurality of head-disk combinations. The embodied invention is independent of the number of hard disks in general and the number of head-disk combinations in general.

The dynamic performance of HDD 110 is a major mechanical factor for achieving higher data capacity as well as for manipulating this data faster. The quantity of data tracks 136 recorded on disk surface 135 is determined partly by how well magnetic head 156 and a desired data track 136 can be positioned to each other and made to follow each other in a stable and controlled manner. There are many factors that will influence the ability of HDD 110 to perform the function of positioning magnetic head 156, and following data track 136 with magnetic head 156. In general, these factors can be put into two categories; those factors that influence the motion of magnetic head 156; and those factors that influence the motion of data track 136. Undesirable motions can come about through unwanted vibration and undesirable tolerances of components. Herein, attention is given to motor-hub assembly 130, which attaches to base casting 113, and in particular, attention is given to the fluid dynamic bearing inside motor-hub assembly 130.

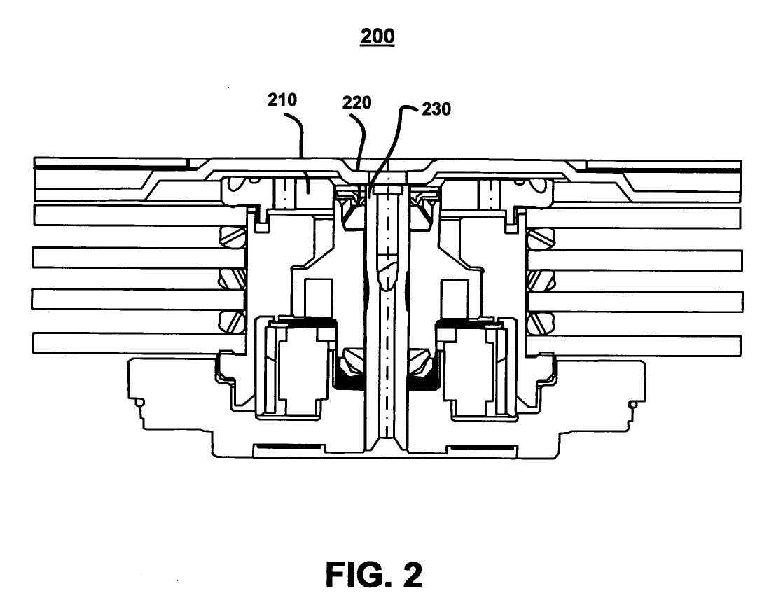

With reference now to FIG. 2, a cross-sectional view of a portion of a fluid dynamic bearing 200 is shown in accordance with one embodiment of the present invention. In one exemplary embodiment, the fluid dynamic bearing 200 includes a plurality of components such as a clamp 210, a bearing cap 220 and a shaft 230. The rest of the components shown of the FDB are well-known in the art and are not described in greater detail for purposes of brevity and clarity. In one embodiment, the components described in fluid dynamic bearing 200 are mirrored at both ends of the fluid dynamic bearing 200 and are not shown for purposes of brevity and clarity.

In general, clamp 210 is utilized to hold at least one disk in place around the FDB 200 while cap 220 is used as a cover to reduce the ability for particulate to enter into the fluid within the FDB. Shaft 230 refers to the stationary or non-rotating portion of the FDB. In operation, the fluid area within the FDB is not a sealed environment but is instead vented to atmospheric pressure. The reasons for venting the FDB are numerous and well-known in the art, but,one important reason for the venting is related to the operational environments within which the FDB is located. For example, the FDB may be part of a hard drive that is used at sea level, on an aircraft, at higher elevation, and the like. As such, there is a need to have an air-gap to allow the air-pressure within the FDB to equalize.

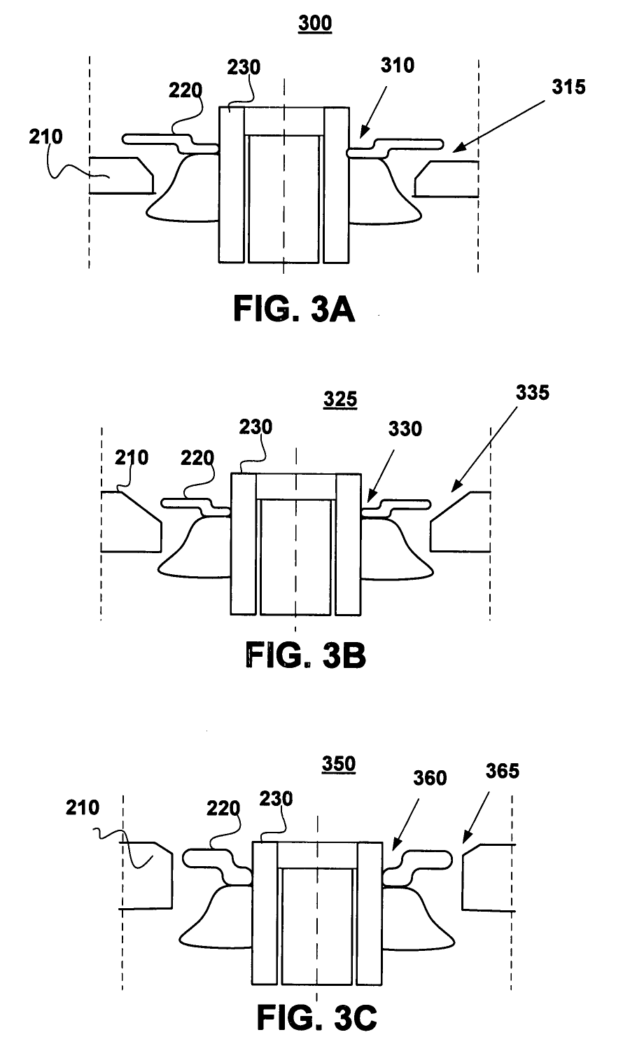

Referring now to FIG. 3A, an isometric view of an exemplary cap 220 clamp 210 orientation having an air-gap 315 with a horizontal opening is shown. Moreover, at FIG. 3A, there is no air-gap 310 between the cap 220 and the shaft 230. With reference now to FIG. 3B, an isometric view of an FDB 325 with a cap 220 clamp 210 orientation having an air-gap 335 with an angled opening is shown. Moreover, at FIG. 3B, there is no air-gap 330 between the cap 220 and the shaft 230.

Referring now to FIG. 3C, an isometric view of an FDB 350 with a cap 220 clamp 210 orientation having an air-gap 365 with a vertical opening is shown. Moreover, at FIG. 3C, there is no air-gap 360 between the cap 220 and the shaft 230. Although three implementations are shown, it is understood that the air-gap may be formed in a plurality of designs or shapes between the cap 220 and the clamp 210. For example, the air-gap may be formed in a straight pattern, a curved pattern and the like. Moreover, any of the cap 220 configurations may be thickened to increase the length of the air-gap opening. For example, as shown in FIG. 3C, the cap 220 may be thickened to increase the length of the air-gap 365 opening. In general, the longer the air-gap 365 the less fluid will evaporate from the FDB. Thus, by reducing the evaporation qualities of the fluid within the FDB, the life of the entire HDD will be extended. The examples of FIGS. 3A, 3B and 3C are merely for purposes of brevity and clarity.

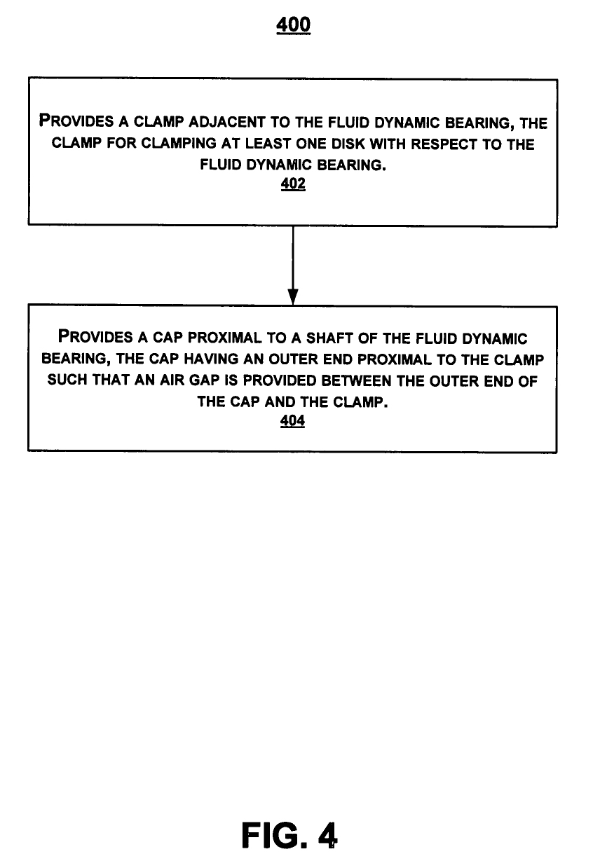

FIG. 4 is a flowchart of a method for forming a fluid dynamic bearing with a modified air-gap in accordance with one embodiment of the present invention. In general, the fluid dynamic bearing generates less NRRO due to the lack of contact between the sleeve and stator than comparable ball bearing spindle motors. Fluid dynamic bearing designs are expected to limit NRRO in the range of 0.01 micro-inch. Other inherent properties of the fluid dynamic bearing design are higher damping, reduced resonance, better non-operational shock resistance, greater speed control, and improved acoustics. Non-operational shock improvement is a result of a much larger area of surface-to-surface contact. Noise levels are reduced to approximately 20 dBA, since there is no contributing noise from ball bearings.

In addition to server class hard drives and desktop hard drives, mobile hard disk drives also use fluid dynamic bearing motors due to the high areal densities that are being achieved with today's technology. Desktop and mobile HDD track densities today are exceeding 100,000 tracks per inch (100 kTPI), which can compound the issues of NRRO. Incorporating FBD motors in the design of desktop and mobile hard drives solves many of the issues of NRRO.

Fluid Dynamic Bearing motors provide improved acoustics over traditional Ball Bearing spindle motors. The source of acoustic noise in the HDD is the dynamic motion of the disk, actuator and spindle motor components. The sound components are generated from the motor magnet, stator, bearings, and disks. These sound components are all transmitted through the spindle motor to the HDD base casting and top cover. Eliminating the bearing noise by use of fluid dynamic bearing spindle motors reduces one area of the noise component that contributes to acoustic noise. In addition, the damping effect of the lubricant film further attenuates noise contributed from the spindle motor components. This results in lower acoustic noise from HDDs employing fluid dynamic bearing spindle motors. Industry data has shown a 4 dBA or more decrease in idle acoustic noise or some HDD designs.

With reference now to 402 of FIG. 4 and to FIG. 2, one embodiment provides a clamp 210 adjacent to the fluid dynamic bearing. In general, the clamp 210 is used to clamp at least one disk 138 with respect to the fluid dynamic bearing 200. In another embodiment, the clamp 210 is used to clamp a plurality of disks 138 with respect to the fluid dynamic bearing 200. In other words, the present technology may be utilized in a single disk hard disk drive or a hard disk drive with a plurality of disks. Moreover, in another embodiment, the present FDB design, is not limited to, and may be used in applications other than hard disk drives.

Referring now to 404 of FIG. 4 and to FIG. 3A, one embodiment provides a cap 220 proximal to a shaft 230 of fluid dynamic bearing 300, the cap 220 having an outer end proximal to clamp 210 such that an air-gap 315 is provided between the outer end of cap 220 and the clamp 210. Moreover, in one embodiment, the inner portion of the cap 220 is located proximal to shaft 230 such that no air-gap 310 is provided between the inside of the cap 220 and the shaft 230. In general, by removing the air-gap 310, the contamination of the fluid within the fluid dynamic bearing is significantly reduced.

As shown in FIG. 3A, in one embodiment, the air-gap 315 is a horizontal opening between the outside end of cap 220 and clamp 210. With reference now to FIG. 3B, in one embodiment, the air-gap 335 is a neither a horizontal nor a vertical opening between the outside end of cap 220 and clamp 210. In other words, the air-gap 335 is at a diagonal. As shown in FIG. 3C, in one embodiment, the air-gap 365 is a vertical opening between the outside end of cap 220 and clamp 210. Moreover, as shown in FIG. 3C, in one embodiment, the cap 220 is thickened to increase the length of the opening to aid in the reduction of evaporation of the fluid within the fluid dynamic bearing 350.

Thus, embodiments of the present invention provide a method and apparatus for forming a fluid dynamic bearing with a modified air-gap. Additionally, embodiments described herein, decrease the contamination of the fluid within the FDB without requiring a modification or change in the viscosity of the fluid in the fluid dynamic bearing. Furthermore, embodiments described herein, provide a fluid dynamic bearing with a modified air-gap without modifying the manufacturing or structure of any components other than the clamp or cap within the fluid dynamic bearing design.

What is claimed is:

1. A method for forming a fluid dynamic bearing with a novel air-gap, said method comprising:
providing a clamp adjacent to said fluid dynamic bearing, said clamp for clamping at least one disk with respect to said fluid dynamic bearing; and
providing a cap proximal to a shaft of said fluid dynamic bearing, said cap having an outer end proximal to said clamp such that an air-gap is provided between the outer end of said cap and the clamp.

2. The method of claim 1 further comprising:
locating an inner portion of said cap proximal to said shaft, such that no air-gap is provided between said inside end of said cap and said shaft.

3. The method of claim 2 further comprising:
providing no air-gap between said inside end of said cap and said shaft to reduce contamination of said fluid dynamic bearing.

4. The method of claim 1 further comprising:
forming said air-gap as a horizontal opening between said outside end of said cap and said clamp.

5. The method of claim 1 further comprising:
forming said air-gap as a vertical opening between said outside end of said cap and said clamp.

6. The method of claim 1 further comprising:
forming said air-gap between said outside end of said cap and said clamp at an angle that is neither horizontal nor vertical.

7. The method of claim 1 further comprising:
thickening the cap such that the depth of said air-gap between said outside end of said cap and said clamp is lengthened.

8. A hard disk drive comprising:
a housing;
at least one disk mounted to the housing and rotatable relative to the housing;
an actuator mounted to the housing and being movable relative to the disk, the actuator having a suspension for reaching over the disk, the suspension having a slider coupled therewith, said slider having a read/write head element on a trailing edge (TE) portion of said slider;
a clamp adjacent to a fluid dynamic bearing, said clamp for clamping said disk with respect to said fluid dynamic bearing; and
a cap adjacent to a shaft of said fluid dynamic bearing, said cap having an outside end proximal to said clamp such that an air-gap is provided between the outside end of said cap and the clamp.

9. The hard disk drive of claim 8 wherein an inner portion of said cap is located adjacent to said shaft, such that no air-gap is provided between said inside end of said cap and said shaft.

10. The hard disk drive of claim 9 wherein said air-gap is not provided between said inside end of said cap and said shaft to reduce contamination of said fluid dynamic bearing.

11. The hard disk drive of claim 8 wherein said air-gap is a horizontal opening between said outside end of said cap and said clamp.

12. The hard disk drive of claim 8 wherein said air-gap is a vertical opening between said outside end of said cap and said clamp.

13. The hard disk drive of claim 8 wherein said air-gap between said outside end of said cap and said clamp is a at an angle that is neither horizontal nor vertical.

14. The hard disk drive of claim 8 wherein a thick cap is utilized such that the depth of said air-gap between said outside end of said cap and said clamp is lengthened.

15. A fluid dynamic bearing with a novel air-gap, said fluid dynamic bearing comprising:
a clamp adjacent to a fluid dynamic bearing, said clamp for clamping at least one of said plurality of disks with respect to said fluid dynamic bearing; and
a cap adjacent to a shaft of said fluid dynamic bearing, said cap having an inside end proximal to said shaft, such that no air-gap is provided between said inside end and said shaft, said cap having an outside end proximal to said clamp such that an air-gap is provided between the outside end of said cap and the clamp.

16. The fluid dynamic bearing with a modified air-gap of claim 15 wherein no air-gap is provided between said inside end of said cap and said shaft to reduce contamination of said fluid dynamic bearing.

17. The fluid dynamic bearing with a modified air-gap of claim 15 wherein said air-gap is a horizontal opening between said outside end of said cap and said clamp.

18. The fluid dynamic bearing with a modified air-gap of claim 15 wherein said air-gap is a vertical opening between said outside end of said cap and said clamp.

19. The fluid dynamic bearing with a modified air-gap of claim 15 wherein said air-gap between said outside end of said cap and said clamp is a at an angle that is neither horizontal nor vertical.

20. The fluid dynamic bearing with a modified air-gap of claim 15 wherein a thick cap is utilized such that the depth of said air-gap between said outside end of said cap and said clamp is lengthened.
